(19) United States
(12) Patent Application Publication
(10) Pub. No.: US 2006/0068138 A1
(43) Pub. Date: Mar. 30, 2006

(54) Glove donning layer containing particles

(76) Inventors: Robert A. Janssen, Alpharetta, GA (US); William E. Conley, Alpharetta, GA (US); Martin S. Shamis, Alpharetta, GA (US)

Correspondence Address: KIMBERLY-CLARK WORLDWIDE, INC., 401 NORTH LAKE STREET, NEENAH, WI, 54956, US

(21) Appl. No.: 10/952,690

(22) Filed: Sep. 29, 2004

(51) Int. Cl. B32B 27/08; E01F 9/04

(52) U.S. Cl. 428/35.7; 428/143

(57) ABSTRACT

An elastomeric article or body having a relatively low friction layer adapted to create a surface with gross rugosities on at least a portion of a first surface of the elastomeric body when the article is exposed to a stretching force is provided. The elastomeric body has a plurality of surface-area-contact reducing particles that have substantially smooth morphology distributed over the low friction layer, which is created from a network of a silicone-modified vinyl acetate polymer. The particles further reduce friction between the first surface and another surface. The low friction layer is stable and adapted to chemically adhere particles substantially permanently to the layer, such that the layer and particles conferring a reduction in relative surface friction when donning the article.

### RELATED APPLICATION

The present invention is related to U.S. patent application Ser. No. 10/454,699, filed in the names of Janssen et al.

### FIELD OF THE INVENTION

The present invention relates to an elastomeric article, and more particularly, to such elastomeric articles having a coating treated to make the articles easer to don or doff.

### BACKGROUND

Elastomeric materials, which combine good elasticity, strength, and barrier protection properties against not only aqueous solutions, but also to many solvents and oils, have been used to form various, different articles, such as surgical gloves, examination or work gloves, condoms, catheters, balloons, tubing, and the like. The elastomeric materials can be either natural rubber or synthetic polymers, such as polyisoprene, nitrile rubbers, polyvinylchloride, polychloroprene, polyurethane, or S-EB-S (styrene-ethylene-butylene-styrene) elastomeric block co-polymers. Elastomeric materials are typically formed so as to be stretched somewhat during normal use. For instance, in some elastomeric gloves, the gloves are formed so as to be stretched during donning in order to fit-tightly against the hand and provide good gripping and tactile characteristics during use. In addition, the gloves should be impermeable to air or liquid substances in order to provide a barrier between the wearer and the environment in which the gloves are used. Unfortunately, the desired characteristics of elastomeric articles also may create a harsh environment for the wearer's skin. For example, perspiration is a common problem for glove wearers, and the resulting moist environment may lead to various skin problems, including, for example, growth of fungi and yeast as well as bacterial and viral infections of the skin. In addition, those who utilize elastomeric articles, such as gloves, are often in clinical conditions that require frequent hand cleaning. For example, clinical personnel must wash their hands or at least wipe their hands with sanitary alcohol formulations many times a day. This constant cleaning may be harsh on the skin, causing excessive skin dryness that may exacerbate skin problems.

Tightly fitting elastomeric article, such as gloves and condoms, whether made of natural or synthetic elastomers, can be difficult to slip on due to blocking, the tendency for an elastomeric material to stick to itself. Also, friction of the elastic material against the skin of the user and perspiration on the body of the user can act in combination to make it difficult to slip on the glove. To overcome this problem, conventional practice has been to apply a powdered lubricant, such as talc or calcium carbonate powders, on the surface that contacts the skin of the user, such as the inside of a glove, to facilitate donning. The powder acts as a barrier between the surface of the article and the skin to make the glove easier to don, as well as to absorb some of the moisture. For example, epichlorohydrin treated maize crosslinked starch is a common powder applied to the inside of elastomeric gloves during manufacture, to permit them to be more readily slipped onto the hand of the user.

While powder on the article surface is still acceptable for some applications, powder has drawbacks and may not be desired for certain applications, such as surgical or other sterile and clean-room uses. If some of the powder escapes from the inside of the glove into the surgical environment, for instance, when if the glove is torn during surgery, the powder may enter the surgical wound to cause complications for the patient. The powder may carry infectious agents, or the patient may be allergic to the powder.

The move in recent years toward powder-free articles has spurred manufacturers to develop alternative ways for providing easier donning articles. Various other techniques are used with surgical or examination gloves to improve their donning characteristics. The techniques include, for examples, manufacturing the glove from a modified latex, using an inner layer of a hydrophilic polymer, applying a slip coating to the inner surface of the glove, providing lubricating particles on the inner surface of the glove, and other approaches.

While these techniques for producing powder-free gloves are perhaps operable in their conventional applications, commercially available alternatives, however have not been fully satisfactory because some degree of blocking and high level of resistance when donning still remains. Hence, a need remains for a new type of donning surface with improved donning characteristics. The present invention satisfies this need through a synergistic interaction of particles and coating layer, and further provides related advantages.

### SUMMARY OF THE INVENTION

The present invention pertains, in part, to a high friction elastomeric body having a relatively low friction layer with gross rugosity on at least a portion of a first surface of the elastomeric body, and a plurality of surface-area-contact reducing particles that have substantially smooth morphology distributed over said low friction layer. The particles further reduce friction between said first surface and another surface. The elastomeric body may be formed into a thin-walled (e.g., ≦1-2 mm), elastomeric article. The elastomeric or polymeric article, such as a glove or condom, that may be readily donned without the use of loose powdered lubricants. The article includes a substrate body formed from an elastomeric material, having a first surface and a low friction coating which forms a donning layer (i.e., inner or wearer-contact surface). The low friction coating contains or is formed from a film or coating of a modified vinyl acetate polymer overlying or adhered to at least a portion of the first surface. In the donning layer are incorporated a number of either organic or inorganic particles or beads chemically bonded to the vinyl acetate polymer molecules. According to an aspect, the low friction layer is a stable polymeric layer adapted to create a surface with gross rugosities when the article is exposed to a stretching force, and adapted to chemically adhere particles, for instance in an embodiment, having exposed surface oxygens, substantially permanently to the polymer layer, and the polymer layer and particles conferring a reduction in relative surface friction when donning the article.

When in contact with either mammalian tissue, such as the user's skin, or another elastomeric surface, the donning layer according to the invention is adapted to make the article slip on or off more easily than conventional powder-free articles. The surprisingly improved donning properties of the present donning layer is believed to result from a synergistic effect of the combination of a modified poly(vinyl acetate) (also referred to as “PVA” polymer) with particles. Desirably, the modified vinyl acetate polymer is a silicone-modified poly(vinyl-acetate) (also referred to as a “PVA-SiO” polymer). The silicone-modified vinyl acetate polymer may contain from about 10 or 15 atomic % to about 30 or 35 atomic % silicon. Typically, the individual particles can have a diameter or size in the range of about 0.05 μm up to about 150 μm. The elastomeric article may further include a lubricant layer overlying at least a portion of the donning layer. The lubricant layer may be formed from a quaternary ammonium compound and a silicone emulsion. Antimicrobial coatings that are non-leaching and include or are derived from quaternary ammonium compound may also be applied.

The present invention also relates to a method of preparing an elastomeric article having a donning layer formed from a silicone-modified vinyl acetate polymer that incorporates organic or inorganic particles. The method includes preparing a substrate body from an elastomeric material, the substrate body having a first surface, and forming a donning layer from a modified vinyl acetate polymer over at least a portion of the first surface. The elastomeric material may be cured either before or after forming the donning layer. The lubricant layer can be formed over at least a portion of the donning layer, and the lubricant layer may include a silicone emulsion.

Additional features and advantages of the present method and resultant treated articles will be disclosed in the following detailed description. It is understood that both the foregoing summary and the following detailed description and examples are merely representative of the invention, and are intended to provide an overview for understanding the invention as claimed.

### BRIEF DESCRIPTION OF FIGURES

FIGS. 1A, 1B, and 1C are scanning electron microscopy (SEM) images collected at 5,000× linear magnification and an angle of 0° tilt, of the donning surface of three different glove samples. FIG. 1A shows the donning layer of a glove that incorporates particles or beads with a polyvinylacetate-silicone polymer (PVA-SiO)-coating, according to the present invention, and depicts the gross rugosities of the coated surface. FIG. 1B shows a PVA-SiO-coated donning layer, but without the particles incorporated thereon. For comparison, FIG. 1C shows the surface of a standard glove surface, without a PVA-SiO-coated donning layer. The scale of each image, in micrometers (μm), is given in the lower right-hand corner.

FIGS. 2A, 2B; and 2C are corresponding SEM images collected at 15,000× linear magnification and an angle of 0° tilt, of the surface of the three glove samples in FIGS. 1A, 1B, and 1C, respectively.

FIGS. 3A, 3B, and 3C are corresponding SEM images collected at 5,000× linear magnification and an angle of 45° tilt, of the surface of the three glove samples in FIGS. 1A, 1B, and 1C, respectively.

FIGS. 4A, 4B, and 4C are corresponding SEM images collected at 15,000× linear magnification and an angle of 45° tilt, of the surface of the three glove samples in FIGS. 1A, 1B, and 1C, respectively.

FIGS. 5A, 5B, and 5C are SEM images collected at 5,000× linear magnification and an angle of 45° tilt, of a cross-sections of the three glove samples in FIGS. 1A, 1B, and 1C, respectively.

FIG. 6A, 6B, and 6C are SEM images collected at 15,000× linear, magnification and an angle of 45° tilt, of a cross-sections of the three glove samples in FIGS. 1A, 1B, and 1C; respectively.

FIG. 7 is a perspective representation of an elastomeric article, namely a glove, according to the present invention.

FIG. 8A is a schematic illustration of a-cross-section of the article in FIG. 7, along a line A-A′, showing a substrate body and a donning layer; and

FIG. 8B is another schematic illustration of a cross-section of the article in FIG. 7, taken along a line A-A′, including a substrate body, a donning layer, and a lubricant layer.

### DETAILED DESCRIPTION OF THE INVENTION

The present invention generally relates to an elastomeric (or “polymeric”) article, such as a condom or glove, and a method of forming such an elastomeric article. As used herein, the term “elastomeric article” refers to an article formed predominantly from an elastomeric material. As used herein, the term “elastomeric material” refers to a polymeric material that is capable of being easily stretched or expanded by about 5-10%, typically 15-25% or more (e.g., 115-125% or more of its original length or dimension), and will substantially return to its previous shape upon release of the stretching or expanding force. An elastomeric material, for example, may include substances such as: a natural rubber, polyisoprene, synthetic isoprene, nitrile rubbers, chloroprene, polyvinylchloride, polychloroprene, polyurethane, S-EB-S (styrene-ethylene-butylene-styrene) elastomeric block co-polymers, styrene-isoprene-styrene block copolymer, styrene-butadiene-styrene block copolymer, styrene-isoprene block co-polymer, styrene-butadiene block copolymer, silicone rubber, acrylic, vinyl acrylic, styrene acrylic, vinyl acetate or vinylidene chloride material latexes or a combination thereof.

Refinement of certain surface chemistry characteristics has enabled the present invention to improve donning characteristics for elastomeric substrates, or articles that incorporate such substrates, and overcome the problems and disadvantages associated with previous donning techniques. In part, the present invention expands upon research that was described in U.S. patent application Ser. No. 10/454,699, the content of which is incorporated herein by reference.

Articles made according to the present invention feature improved donning characteristics without the use of loose powders. Such articles include a donning layer formed from a silicone-modified vinyl acetate polymer having either inorganic or organic material particles, or a combination of both, integrated therein. This provides a significant advantage over powder-coated articles, which require additional processing steps to remove excess powder and are not suitable for some applications, such as surgical, examination, or work gloves. As used herein, the term “silicone” generally refers to a broad family of synthetic polymers that have a repeating silicon-oxygen backbone, including, but not limited to, polydimethylsiloxane and polysiloxanes having hydrogen-bonding functional groups selected from the group consisting of amino, carboxyl hydroxyl, ether, polyether, aldehyde, ketone, amide, ester, and thiol groups.

In contrast to others who use solutions of various polymers, with liquid silicones, the present surface preparation is based upon a PVA-silicone latex dispersion. The polyvinylacetate (PVA) is made in the form of a latex, not a solution. Silicone is chemically grafted to the base latex surface. This “locks” the silicone in place on the latex particles and prevents future migration. The PVA-silicone exhibits an affinity towards particles or other units which have a polar character. This is due in part to the polar nature of the PVA latex. In the present invention, we take advantage of this affinity characteristic to incorporate particles in and on the latex. To the surface of the elastomeric material substrate, we apply a coating or film containing a polyvinylacetate-silicone polymer (PVA-SiO) and having an amount of particles: chemically bonded or incorporated in the matrix of the coating. This creates a low friction surface. Generally, an emulsion of polyvinyl alcohol, acetates, silicone and other hydrophilic components is prepared to achieve different degrees of hydrolysis, which according to the invention, is about 0.1% to about 35% hydrolysis. Desirably the amount of hydrolysis is about 1-20%, and more desirably about less than 18% or 15%.

Particular amounts can range from about 1.5% to 10% or 12%. Desirably, the particles are distributed uniformly throughout the thickness of the coating layer, which can range from about 0.5 μm to about 100 μm or 120 μm, but more typically is about 1 or 2 μm to about 70 or 80 μm. According to certain embodiments, the concentration of particles can be higher at the skin or wearer-interface surface of the donning layer, and may be lower relative to the rest of the coating. The amount of particles present in the coating ranges from about 2 to about 35 weight percent (wt. %), preferably about 5 to 30 wt. %, or about 10 to 25 wt. % of the coating, and more preferably about 12-18 wt. %. Generally, the particles are on the coating at a surface density of at least approximately 150-200 particles up to about 50,000 or 75,000 per cm². Preferably, the surface density of the particle is in the range of about 2,000 to 35,000 per cm².

According to the present invention, it is believed that the polar nature of the polyvinyl acetate (PVA) polymer coating facilitates attachment and binding of the particles. This is accomplished, in part, through the ionic bonding of the hydroxyl groups on the PVA and the polar nature of the silicone particles. Although others have incorporated silicone-modified polymer and silicone resin particles as a coating, such as described in U.S. Pat. No. 6,638,587 to Wang et al., they have needed to prefunctionalize the silicone particles with a polymer so as to make them reactive with the polymer coating. That is, they have coated their particles with another polymer so that the coated particle can react with the polymer that is used to coat the gloves. An approach such as by Wang et al. involves complex chemistries and requires several process steps, hence more time consuming to perform than the present invention, which is much simpler and easier to implement and more conducive to a production mode. With the present invention, one need not precoat the silica particles when forming or applying the donning coat, since the particles will react directly with the PVA material through an ionic attraction of the silica and the hydroxyl groups present in the PVA coating material.

While some donning layer polymers have been traditionally selected to have elastomeric characteristics so that the donning layer is able to stretch and recover in concert with the substrate body without peeling away or flaking off, it has been discovered that the glove of the present invention is able to provide a non-elastomeric donning layer that does not spall, even under the stress of being stretched and deformed.

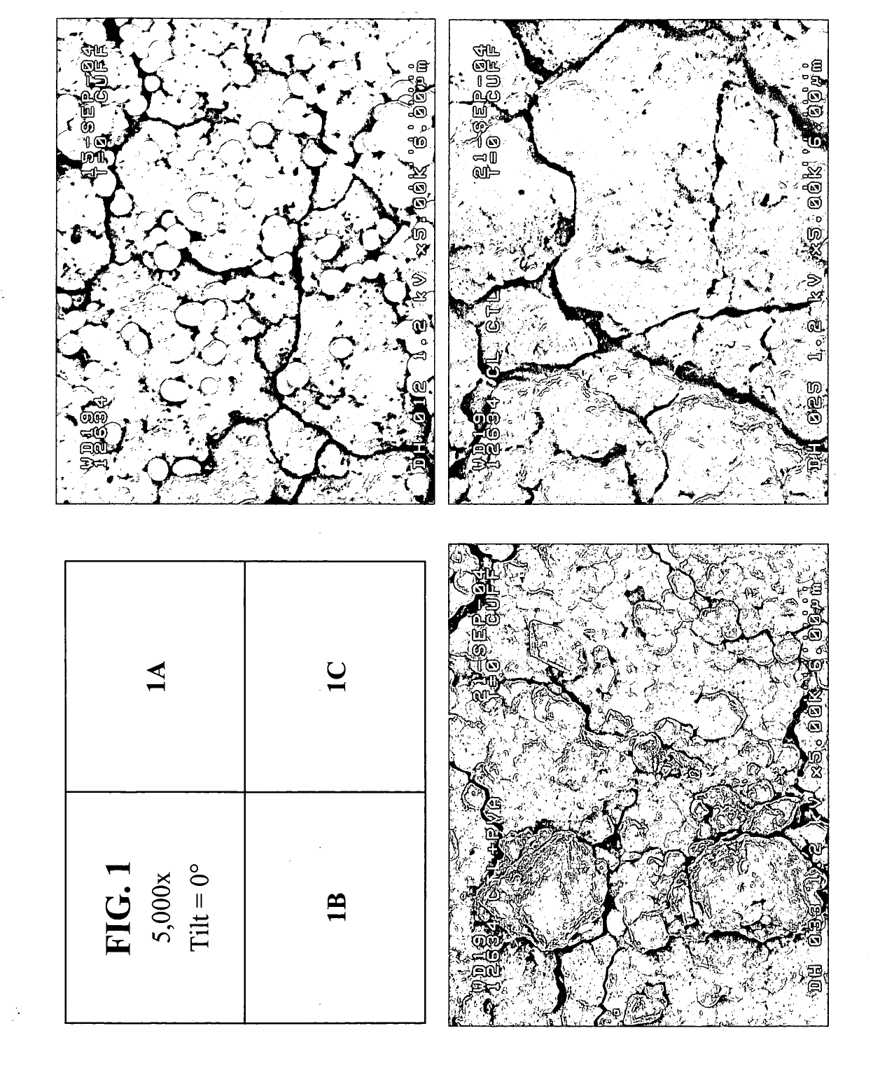

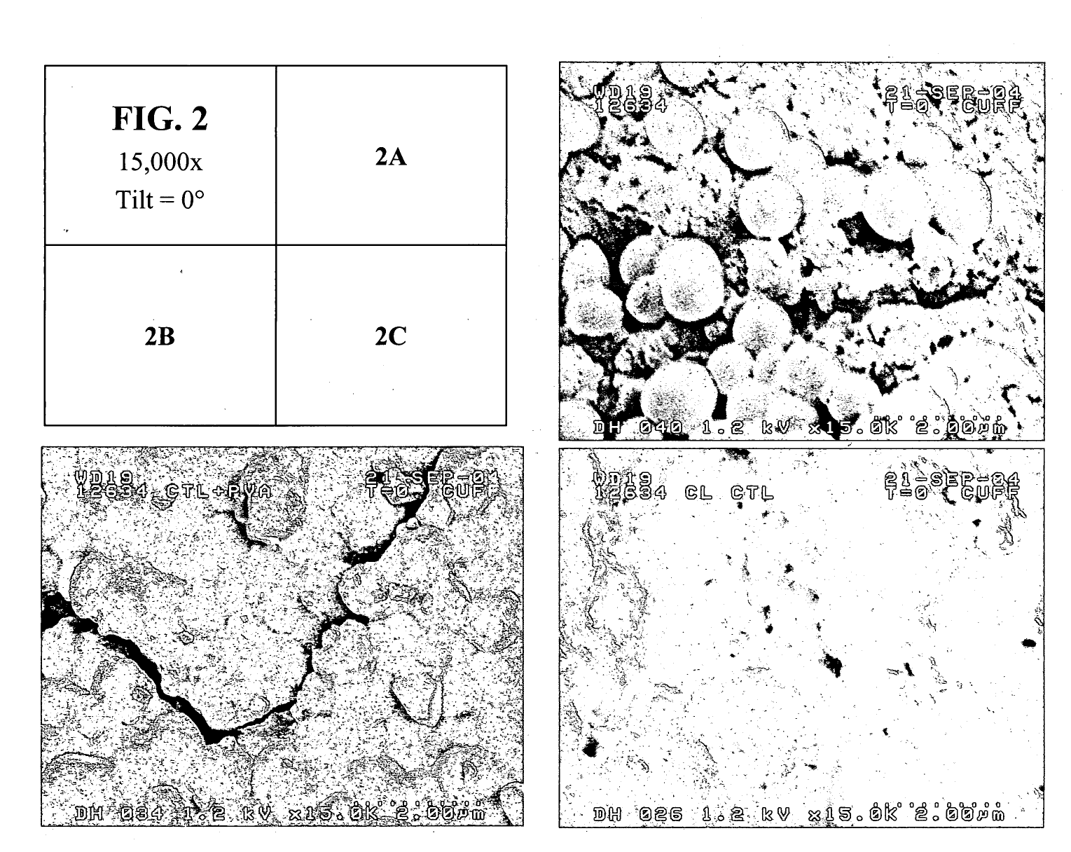

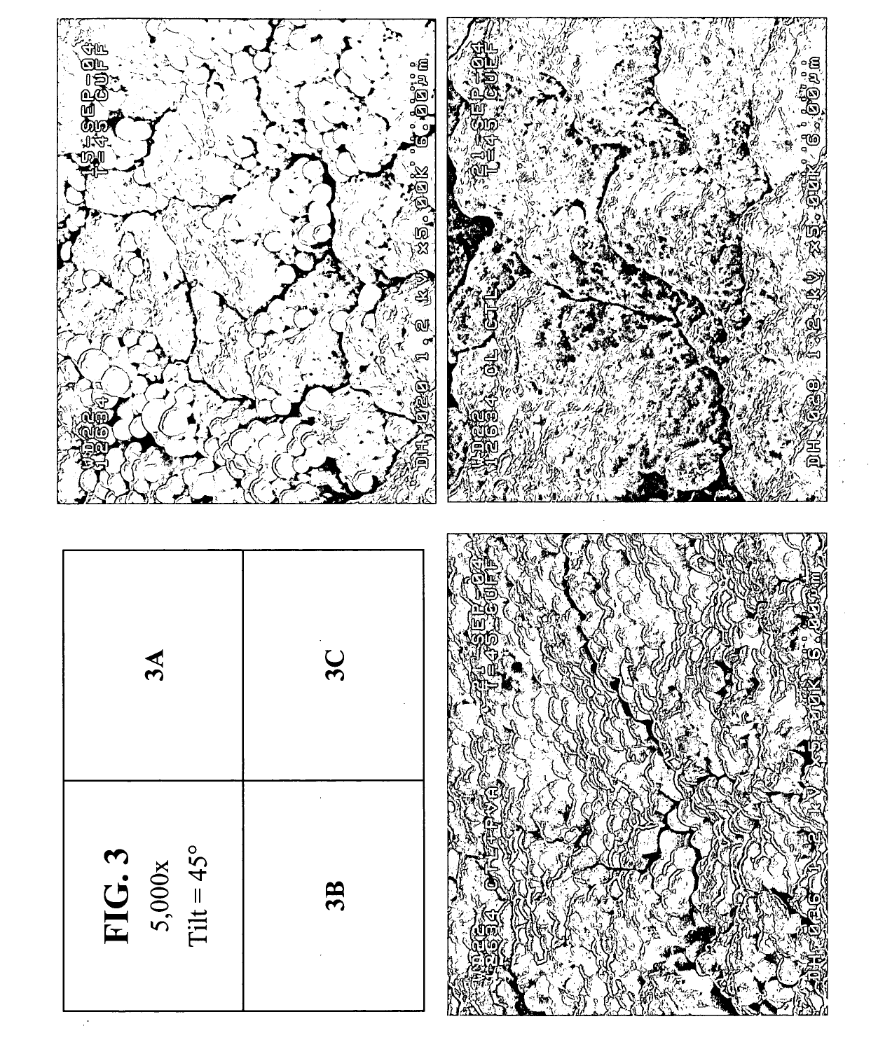

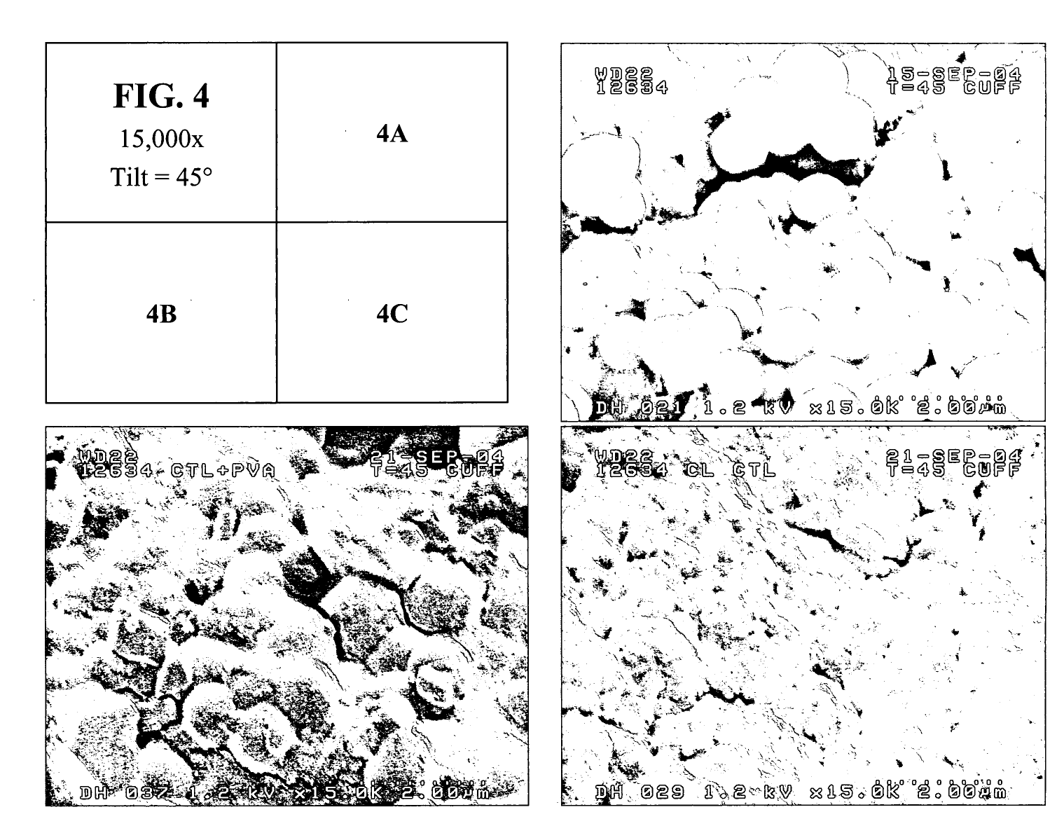

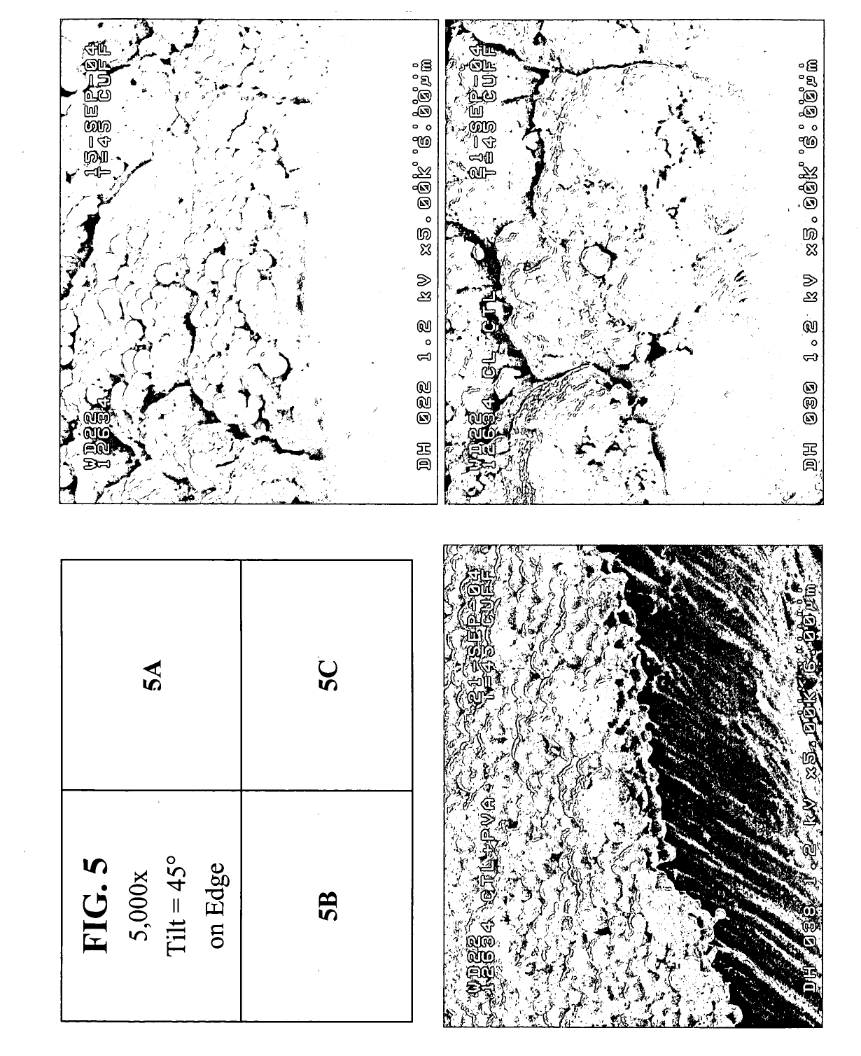

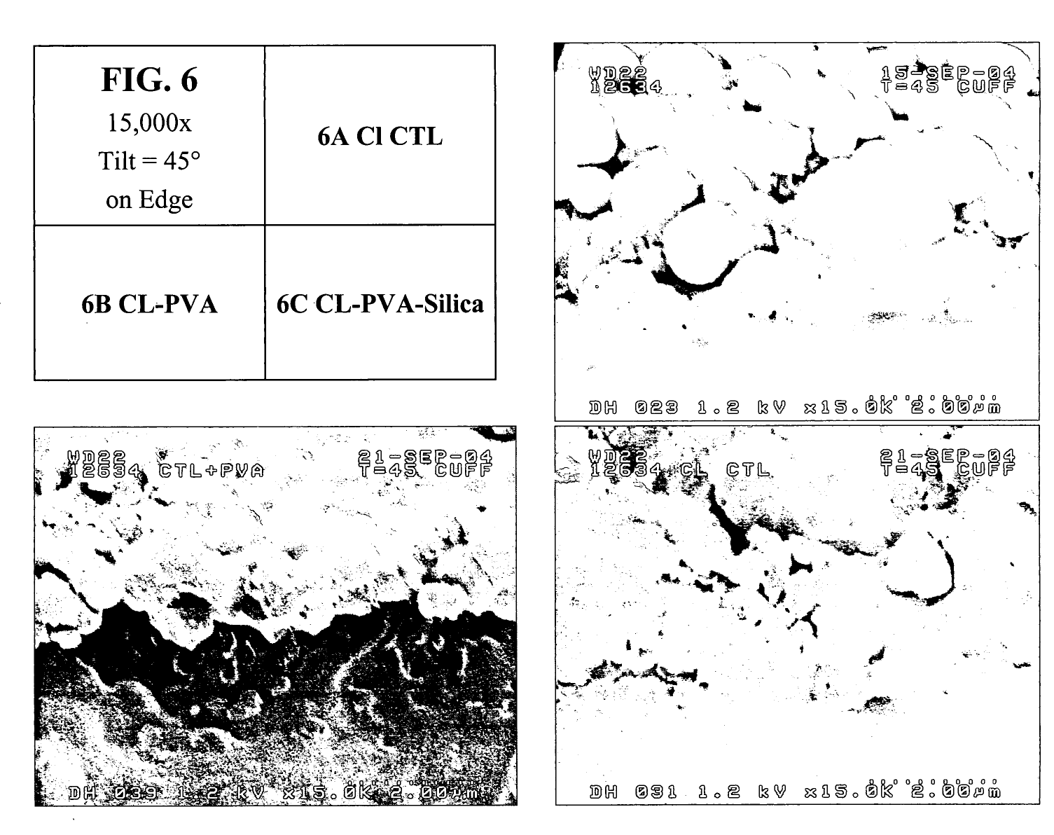

Reference to the accompanying figures may help in the understanding of the invention. FIGS. 1-6 are scanning electron micrograph (SEM) images taken at different linear magnifications: 5,000× and 15,000×. Samples were imaged at both an angle of 0° and 45° tilt. Sub-samples from either along- the cuff or palm regions of each glove were gold coated and examined at 1.2 keV with a Hitachi S-4500 field emission SEM. The images show the donning surface characteristics of three gloves, corresponding in each set of figures to one (A) that is coated with a modified PVA-SiO donning coat with particles of the present invention, a second (B) having a PVA layer applied, and a third, as a control (C), that is merely chlorinated and having no other treatment. Each of the gloves is formed using a conventional manufacture process. FIGS. 1A and 1B of the modified donning layer on an elastomeric surface of a latex glove after being subjected to a stretching force and allowing the glove to retract. In FIG. 1A, the donning layer contains a number of particles bond to the coating, according to the present invention, whereas FIG. 1B is a comparative image of the same PVA-SiO coating material absent particles. The coating layer has a high degree of gross rugosity, that is a rough and ridged surface with creases and wrinkles, which helps break up the surface and reduces the tendency for resistive forces or a high coefficient of friction to develop over large areas of smooth surface. FIGS. 2A-2C show images of the same gloves at 15,000× linear magnification corresponding to FIGS. 1A-1C, respectively. The images show that the surfaces that incorporated particles to the PVA surface, and even the surface coated with PVA alone has a relatively greater rugosity than the conventional glove surface. While not wishing to be bound by any particular theory, it is believed that the donning layer polymer and the attached particles result in larger ridges or bumps that removes or elevates the wear's skin from the overall glove surface when the glove is donned, hence making contact with the inner 15 surface relatively more remote, hence lessening overall friction between skin and glove. The images in FIGS. 3-6 appear to confirm this interpretation.

The polymer donning layer develops microscopic fractures when the glove is exposed to a stretching force. Despite the generation of such fractures, it has been demonstrated that the donning layer formed from a silicone-modified vinyl acetate polymer does not delaminate from the substrate surface. When used to coat the donning side of the elastomeric substrate, such as either a latex or nitrile glove, the modified PVA-SiO emulsion, upon drying, will become permanently bonded to the base substrate material, and will not “flake off” when stretched. Thus, beneficial donning characteristics are obtained from a non-elastomeric polymer without the use of conventional, loose powders.

Surprisingly, and rather counter intuitively in the present invention, the cracked surface roughness in combination with incorporated particles or beads appears to contribute to the improved donning characteristics of the elastomeric article. Addition of organic or inorganic particles to a modified vinyl acetate polymer coating (preferably, e.g., polyvinylacetate-silicone polymer), it is believed, contributes to a frictional differential of the surface. In other words, the particles or beads present in the coating layer will further reduce the surface frictional properties of the coated article. The particles are associated with the polymer backbone and should be bonded to the base PVA-silicone polymer by either a primary (covalent) or secondary (ionic or charge-based) chemical bond. Mere physical entrapment of the particles in the polymer matrix will not prevent the particles from spalling or popping out of the donning layer when the elastomeric article is stretched in use. The particles or beads can be incorporated directly into the polymer backbone of the PVA-SiO polymer at the time of synthesis or it can be attached at a subsequent operation. This subsequent attachment, for instance, can be achieved by means of residual acetate linkages or the hydroxyl group resulting from the hydrolysis of the acetate group from the polymer backbone. Alternatively, the PVA-SiO polymer may be copolymerized with another monomer that would result in the direct bonding of the particle to this moiety.

Particles or beads that are incorporated in the donning layer may be selected from a variety of organic or inorganic materials, as characterized as the material can be chemically attached to the backbone of a modified polyvinyl-acetate polymer chain. That is, a material that can form an attachment either through covalent bond or charged affinity. Organic materials, for instance, may include natural substances, such as oat, corn, and/or other starches, or various synthetic polymers, for example, silicone, silane, siloxane, acrylate or polymethacrylate, or high-molecular weight (e.g., ≧5,000) polyolefin polymers. Inorganic materials may include, for example, talcum (Mg₃Si₄O₁₀(OH)₂), silica (SiO₂), alumina (Al₂O₃), titania (TiO₂), zirconia (ZrO₂), CaO₂, ZnO₂, Cr₂O₃, CeO₂, Ge₂O₃, or other oxides of alkaline earth metals, transition metals, or rare earth metals, or various forms of glass or ceramic beads (e.g., aluminosilicates, borosilicates, boroaluminosilicates, or silicates). The individual particles have a smooth morphology, absent sharp edges that may catch or damage skin tissue or the elastomeric material. Hence, preferably, the particles are generally either perfect spheroids or irregular or elongated oblate forms.

According to a first embodiment, the particles incorporated may be all selected from a single or similar material, or in a second embodiment, the particles may be selected from various combinations of either organic or inorganic materials, or in a third embodiment, particles can have a mixture of both organic and inorganic materials. Preferably, the particles are inorganic, in particular if the material is an oxide. Exposed oxygen atoms on the particle surface can readily react with the polymer backbone. If the material is not well adapted to form a linkage with the PVA backbone, the particles or their surfaces may be either doped, modified or otherwise adapted with organic constituent components, which can make them more susceptible to forming covalent bonds with the polyvinyl acetate polymer backbone. For instance, the organic component may have a hydroxyl, or a carboxyl or carbonyl acid or aldehyde functional group that can react to form an ester linkage, an epoxy to form an ether linkage, or isocynates to form an urethane linkage.

The likely size of the individual particles is independent of the type of material from which they are made. In some embodiments, the individual particles can be suspended as colloids, with a size of approximately 5 Å to 5,000 Ångstroms, in a medium during the coating and fabricatiori process. More typically, however, the particles can range in size from about 0.1 micrometers (μm) to about 100 μm or 110 μm. Desirable sizes can range from as small as about 0.5 μm or 1 μm up to about 60 μm or 75 μm More preferred sizes can range from about 1 μm or 2 μm up to about 40 μm or 50 μm. More typically, the particles may be in the range of about 6-10 μm, up to about 30 μm. In a single donning layer, it is possible to have a distribution of particles with different sizes in the same coating. A particle size distribution will also result in a more easily donnable glove surface, for instance, as compared to having little or no particles present. It would be desirable, however, to have the particles all of the same size. This will aid in the processing of these particles in the coating formulation by keeping them uniformly suspended prior to application to the glove.

The present invention also is commercially cost affective. Given that polyurethane and acrylic materials, are currently either the first or second most expensive base materials used for commercial donning coats, manufactures have searched for a more cost effective material for fabricating a donning coat. Application of the present new coating-material blend can reduce the cost of manufacture by as much as about 20% relative to the cost for acrylic or polyurethane coatings. By itself, poly-vinyl acetate is not a suitable nor desirable material for improving donning characteristics, since it does not work for anti-blocking purposes. Surprisingly, however, we have found that a modified poly-vinyl acetate is both economical and can serve well as a base for the donning layer. After modification to include a silicone copolymer and particles, the modified poly-vinyl acetate-silicone polymer can be applied to an elastomeric surface such as of a glove to create a donning coating that allows the glove to easily side on to off the wearer's hand, with minimal assistance.

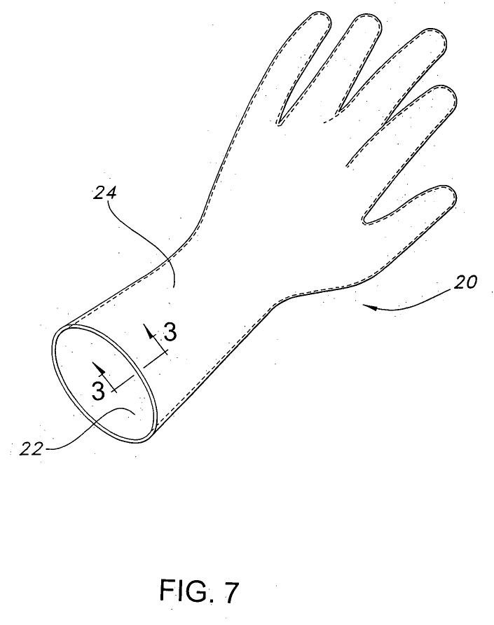

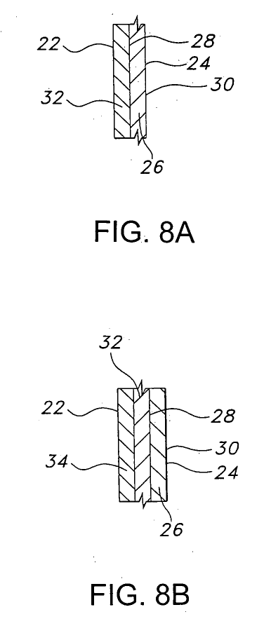

Having a potential wide range of applications, the present invention will be discussed in the context of a glove, for purposes of illustration, but this in no way limits the invention to 30 any particular type of article. A glove 20, such as depicted in FIG. 7, generally includes an inside surface 22 and an outside surface 24. As used herein, the “inside surface” refers to the surface of the article that contacts the body of the wearer. As used herein, the “outside surface” refers to the surface of the article that is distal from the body of the wearer. The glove includes a substrate body 26 having a first surface 28 and a second surface 30 (FIG. 8A-8B). As used herein, “first surface” refers to the surface of the substrate body proximal to the body of the wearer. As used herein, “second surface” refers to the surface of the substrate body distal to the body of the wearer.

The article of the present invention may include a single layer or multiple layers as desired. In a single layer glove including only the substrate body, the first surface may form the inside surface of the glove. In a multi-layer glove having additional layers proximal to the body of the wearer, however, the additional layer or layers may each form a portion of the inside surface, or the entire inside surface, as desired. Likewise, in a single layer glove including only the substrate body, the second surface may form the outside surface of the glove. In a multi-layer glove having additional layers distal from the body of the wearer, however, the additional layer or layers may each form a portion of the outside surface, or the entire outside surface, as desired.

For example, as depicted in FIG. 8A, the article may include a donning layer 32 overlying at least a portion of the first surface 28 of the substrate body 26. In such an article, the donning layer 32 forms at least a portion of the inside surface 22 of the glove 20. As depicted in FIG. 8B, the article may also include other layers, such as a lubricant layer 34 that overlies at least a portion of the donning layer 32. In such an article, the lubricant layer 34 forms at least a portion of the inside surface 22 of the glove 20.

The substrate body 26 (FIGS. 8A-8B) may be formed from any suitable elastomeric material, and in some embodiments, the substrate body may be formed from natural rubber, which is typically provided as a natural rubber latex. In other embodiments, the elastomeric material may include nitrile butadiene rubber, and in particular, may include carboxylated nitrile butadiene rubber. While articles formed from natural rubber and nitrile rubber are described in detail herein, it should be understood that any other suitable polymer or combination of polymers may be used with the present invention. For instance, the substrate body may be formed from a styrene-ethylene-butylene-styrene (S-EB-S) block copolymer. In some embodiments, the body may be formed from two or more elastomeric materials. For instance, the body may be formed from two or more S-EB-S block copolymers, such as those described in U.S. Pat. Nos. 5,112,900 and 5,407,715, to Buddenhagen et al., both incorporated herein by reference in their entirety. In other embodiments, the elastomeric material may include a styrene-isoprene-styrene block copolymer, styrene-butadiene-styrene block copolymer, styrene-isoprene block copolymer, styrene-butadiene block copolymer, synthetic isoprene, chloroprene rubber, polyvinyl chloride, silicone rubber, or a combination thereof.

The donning layer 32 (FIGS. 8A-8B) may be formed from any polymer that facilitates donning and generally includes a vinyl acetate polymer modified with silicone. The silicone-modified vinyl acetate polymer may include any suitable silicon content, and in some instances, the silicone-modified vinyl acetate polymer may include from about 10 atomic % to about 30 atomic % silicon. In other instances, the silicone-modified vinyl acetate polymer may include from about 15 atomic % to about 25 atomic % silicon. As used herein, atomic percent (atomic %) refers to the number of atoms of an element per unit volume divided by the number of atoms per unit volume of the substance containing the element. In yet other instances, the silicone-modified vinyl acetate polymer may include from about 17 atomic % to about 22 atomic % silicon. In one such embodiment, the silicone-modified vinyl acetate polymer may include about 17.7 atomic % silicon. In another such embodiment, the silicone-modified vinyl acetate polymer may include about 21.8 atomic % silicon.

One such silicone modified vinyl acetate polymer that may be suitable for use with the present invention is commercially available from Reichhold Chemicals, Inc. (Research Triangle Park, N.C.) under the trade name Synthemul® 97907-00 synthetic resin emulsion. Synthemul® 97907-00 synthetic resin emulsion is believed to be a carboxylated vinyl acetate latex that contains about 46 mass % modified vinyl acetate polymer, about 56 mass % water, and small amounts of vinyl acetate monomer. Another modified vinyl acetate polymer that may be suitable for use with the present invention is also commercially available from Reichhold Chemicals, Inc. (Research Triangle Park, N.C.) under the trade name Synthemul® 97635-00 synthetic resin emulsion. Synthemul® 97635-00 synthetic resin emulsion is believed to be a vinyl acetate homopolymer that contains about 46 mass % vinyl acetate homopolymer, about 56 mass % water, and small amounts of vinyl acetate monomer. While exemplary modified vinyl acetate polymers are set forth herein, it should be understood that any suitable modified vinyl acetate polymer may be used with the present invention.

The article of the present invention may include a lubricant layer 34 overlying at least a portion of the donning layer 32 to further facilitate donning (FIG. 8B). In one embodiment, the lubricant layer may contain a silicone or silicone-based component. In some embodiments, polydimethylsiloxane and/or modified polysiloxanes may be used as the silicone component in accordance with the present invention. For instance, some suitable modified polysiloxanes that can be used in the present invention include, but are not limited to, phenyl-modified polysiloxanes, vinyl-modified polysiloxanes, methyl-modified polysiloxanes, fluoro-modified polysiloxanes, alkyl-modified polysiloxanes, alkoxy-modified polysiloxanes, amino-modified polysiloxanes, and combinations thereof.

In some embodiments, the lubricant layer may include a silicone emulsion. One such silicone emulsion, that may be suitable for use with the present invention is DC 365, a pre-emulsified silicone (˜35% total solids content (TSC)) that is, commercially available from Dow Corning Corporation (Midland, Mich.). DC 365 is believed to contain 40-70 mass % water (aqueous solvent), 30-60 mass % methyl-modified polydimethylsiloxane (silicone), 1-5 mass % propylene glycol (non-aqueous solvent), 1-5 mass % polyethylene glycol sorbitan monolaurate (nonionic surfactant), and 1-5 mass % octylphenoxy polyethoxy ethanol (nonionic surfactant). Another silicone emulsion that may be suitable for use with the present invention is SM 2140, commercially available from GE Silicones (Waterford, N.Y.).

SM 2140 is a pre-emulsified silicone (˜50% TSC) that is believed to contain 30-60 mass % water (aqueous solvent), 30-60 mass % amino-modified polydimethylsiloxane (silicone), 1-5% ethoxylated nonyl phenol (nonionic surfactant), 1-5 mass % trimethyl-4-nonyloxypolyethyleneoxy ethanol (nonionic surfactant), and minor percentages of acetaldehyde, formaldehyde, and 1,4 dioxane. Another silicone emulsion that may be suitable for use with the present invention is SM 2169 available from GE Silicones (Waterford, N.Y.). SM 2169 is a pre-emulsified silicone that is believed to contain 30-60 mass % water, 60-80 mass % polydimethylsiloxane, 1-5 mass % polyoxyethylene lauryl ether, and a small amount of formaldehyde. Yet another silicone that may be suitable for use with the present invention is commercially available from GE Silicones (Waterford, N.Y.) under the trade name AF-60. AF-60 is believed to contain polydimethylsiloxane, acetylaldehyde, and small percentages of emulsifiers. If desired, these pre-emulsified silicones may be diluted with water or other solvents prior to use.

In another embodiment, the lubricant layer may contain a quaternary ammonium compound, such as that commercially available from Goldschmidt Chemical Corporation of Dublin, Ohio. under the trade name VERISOFT® BTMS. VERISOFT® BTMS is believed to contain behenyl trimethyl sulfate and cetyl alcohol. Thus for example, in one embodiment, the lubricant layer includes a quatemary ammonium compound such as VERISOFT® BTMS and a silicone emulsion such as SM 2169.

In other embodiments, the lubricant layer may include, for example, a cationic surfactant (e.g., cetyl pyridinium chloride), an anionic surfactant (e.g., sodium lauryl sulfate), a nonionic surfactant, or the like.

In some embodiments, one or more cationic surfactants may be used. Examples of cationic surfactants that may be suitable for use-with the present invention include, for example, behenetrimonium methosulfate, distearyldimonium chloride, dimethyl dioctadecyl ammonium chloride, cetylpyridinium chloride, methylbenzethonium chloride, hexadecylpyridinium chloride, hexadecyltrimethylammonium chloride, benzalkonium chloride, dodecylpyridinium chloride, the corresponding bromides, hydroxyethylheptadecylimidazolium halides, coco aminopropyl betaine, and coconut alkyldimethylammonium betaine. Additional cationic surfactants that may be used include methyl bis(hydrogenated tallow amidoethyl)-2-hydroxyethly ammonium methyl sulfate, methyl bis(tallowamido ethyl)-2-hydroxyethyl ammonium methyl sulfate, methyl bis(soya ainidoethyl)-2-hydroxyethyl ammonium methyl sulfate, methyl bis(canola amidoethyl)-2-hydroxyethyl ammonium methyl sulfate, methyl bis(tallowamido ethyl)-2-tallow imidazolinium methyl sulfate, methyl bis(hydrogenated tallowamido ethyl)-2-hydrogenated tallow imidazolinium methyl sulfate, methyl bis(ethyl tallowate)-2-hydroxyethyl ammonium methyl sulfate, methyl bis(ethyl tallowate)-2-hydroxyethyl ammonium methyl sulfate, dihydrogenated tallow dimethyl ammonium chloride, didecyl dimethyl ammonium chloride, dioctyl dimethyl ammonium chloride, octyl decyl dimethyl ammonium chloride diamidoaamine ethoxylates, diamidoamine imidazolines, and quaternary ester salts.

In some embodiments, one or more nonionic surfactants may be used. Nonionic surfactants typically have a hydrophobic base, such as a long chain alkyl group or an alkylated aryl group, and a hydrophilic chain comprising a certain number (e.g., 1 to about 30) of ethoxy and/or propoxy moieties. Examples of some classes of nonionic surfactants that may be used include, but are not limited to, ethoxylated alkylphenols, ethoxylated and propoxylated fatty alcohols, polyethylene glycol ethers of methyl glucose, polyethylene glycol ethers of sorbitol, ethylene oxide-propylene oxide block copolymers, ethoxylated esters of fatty (C₈ -C₁₈) acids, condensation products of ethylene oxide with long chain amines or amides, condensation products of ethylene oxide with alcohols, and mixtures thereof.

Specific examples of suitable nonionic surfactants include, but are not limited to, methyl gluceth-10, PEG-20 methyl glucose distearate, PEG-20 methyl glucose sesquistearate, C₁₁₋₁₅ pareth-20, ceteth-8, ceteth-12, dodoxynol-12, laureth-715, PEG-20 castor oil, polysorbate 20, steareth-20, polyoxyethylene-10 cetyl ether, polyoxyethylene-10 stearyl ether, polyoxyethylene-20 cetyl ether, polyoxyethylene-10 oleyl ether, polyoxyethylene-20 oleyl ether, an ethoxylated nonylphenol, ethoxylated octylphenol, ethoxylated dodecylphenol, or ethoxylated fatty (C₆ -C₂₂) alcohol, including 3 to 20 ethylene oxide moieties, polyoxyethylene-20 isohexadecyl ether, polyxyethylene-23 glycerol laurate, polyoxy-ethylene-20 glyceryl stearate, PPG-10 methyl glucose ether, PPG-20 methyl glucose ether, polyoxyethylene-20 sorbitan monoesters, polyoxyethylene-80 castor oil, polyoxyethylene-15 tridecyl ether, polyoxy-ethylene-6 tridecyl ether, laureth-2, laureth-3, laureth-4, PEG-3 castor oil, PEG 600 dioleate, PEG 400 dioleate, oxyethanol, 2,6,8-trimethyl-4-nonyloxypolyethylene oxyethanol; octylphenoxy polyethoxy ethanol, nonylphenoxy polyethoxy ethanol, 2,6,8-trimethyl-4-nonyloxypolyethylene alkyleneoxypolyethyleneoxyethanol, alkyleneoxypolyethyleneoxyethanol, alkyleneoxypolyethyleneoxyethanol, and mixtures thereof.

Additional nonionic surfactants that may be used include water soluble alcohol ethylene oxide condensates that are the condensation products of a secondary aliphatic alcohol containing between about 8 to about 18 carbon atoms in a straight or branched chain configuration condensed with between about 5 to about 30 moles of ethylene oxide. Such nonionic surfactants are commercially available under the trade name TERGITOL® from Union Carbide Corp. (Danbury, Conn.). Specific examples of such commercially available nonionic surfactants of the foregoing type are C₁₁-C₁₅. secondary alkanols condensed with either 9 moles of ethylene oxide (TERGITOL® 15-S-9) or 12 moles of ethylene oxide (TERGITOL® 15-S-12) marketed by Union Carbide Corp. (Danbury, Conn.).

Other suitable nonionic surfactants include the polyethylene oxide condensates of one mole of alkyl phenol containing from about 8 to 18 carbon atoms in a straight or branched chain alkyl group with about 5 to 30 moles of ethylene oxide. Specific examples of alkyl phenol ethoxylates include nonyl condensed with about 9.5 moles of ethylene oxide per mole of nonyl phenol, dinonyl phenol condensed with about 12 moles of ethylene oxide per mole of phenol, dinonyl phenol condensed with about 15 moles of ethylene oxide per mole of phenol and diisoctylphenol condensed with about 15 moles of ethylene oxide per mole of phenol. Commercially available nonionic surfactants of this type include IGEPAL® CO-630 (a nonyl phenol ethoxylate) marketed by ISP Corp. (Wayne, N.J.). Suitable non-ionic ethoxylated octyl and nonyl phenols include those having from about 7 to about 13 ethoxy units.

In some embodiments, one or more amphoteric surfactants may be used. One class of amphoteric surfactants that may suitable for use with the present invention includes the derivatives of secondary and tertiary amines having aliphatic radicals that are straight chain or branched, where one of the aliphatic substituents contains from about 8 to 18 carbon atoms and at least one of the aliphatic substituents contains an anionic water-solubilizing group, such as a carboxy, sulfonate, or sulfate group. Some examples of amphoteric surfactants include, but are not limited to, sodium 3-(dodecylamino)propionate, sodium 3-(dodecylamino)-propane-1-sulfonate, sodium 2-(dodecylamino)ethyl sulfate, sodium 2-(dimethylamino)octadecanoate, disodium 3-(N-carboxymethyl-dodecylamino)propane-1-sulfonate, sodium 1-carboxymethyl-2-undecylimidazole, disodium octadecyliminodiacetate, and sodium N,N-bis(2-hydroxyethyl)-2-sulfato-3-dodecoxypropylamine.

Additional classes of suitable amphoteric surfactants include phosphobetaines and phosphitaines. For instance, some examples of such amphoteric surfactants include, but are not limited to, sodium coconut N-methyl taurate, sodium oleyl N-methyl taurate, sodium tall oil acid N-methyl taurate, cocodimethylcarboxymethylbetaine, lauryldimethylcarboxymethylbetaine, lauryldimethylcarboxyethylbetaine, cetyldimethylcarboxymethylbetaine, sodium palmitoyl N-methyl taurate, oleyldimethylgammacarboxypropylbetaine, lauryl-bis-(2-hydroxypropyl)-carboxyethylbetaine, di-sodium oleamide PEG-2 sulfosuccinate, laurylamido-bis-(2-hydroxyethyl)propylsultaine, lauryl-bis-(2-hydroxyethyl)carboxymethylbetaine, cocoamidodimethylpropylsultaine, stearylamidodimethylpropylsultaine, TEA oleamido PEG-2 sulfosuccinate, disodium oleamide MEA sulfosuccinate, disodium oleamide MIPA sulfosuccinate, disodium ricinolearnide MEA sulfosuccinate, disodium undecylenamide MEA sulfosuccinate, disodium wheat germamido MEA sulfosuccinate, disodium wheat germamido PEG-2 sulfosuccinate, disodium isosteararnideo MEA sulfosuccinate, cocoarnido propyl monosodium phosphitaine, lauric myristic amido propyl monosodium phosphitaine, cocoamido disodium 3-hydroxypropyl phosphobetaine, lauric myristic amido disodium 3-hydroxypropyl phosphobetaine, lauric myristic amido glyceryl phosphobetaine, lauric myristic amido carboxy disodium 3-hydroxypropyl phosphobetaine, cocoamphoglycinate, cocoamphocarboxyglycinate, capryloamphocarboxyglycinate, lauroamphocarboxyglycinate, lauroamphoglycinate, capryloamphocarboxypropionate, lauroamphocarboxypropionate, cocoamphopropionate, cocoamphocarboxypropionate, dihydroxyethyl tallow glycinate, and mixtures thereof.

In certain instances, one or more anionic surfactants may be used. Suitable anionic surfactants include, but are not limited to, alkyl sulfates, alkyl ether sulfates, alkyl ether sulfonates, sulfate esters of an alkylphenoxy polyoxyethylene ethanol, alpha-olefin sulfonates, beta-alkoxy alkane sulfonates, alkylauryl sulfonates, alkyl monoglyceride sulfates, alkyl monoglyceride sulfonates, alkyl carbonates, alkyl ether carboxylates, fatty acids, sulfosuccinates, sarcosinates, octoxynol or nonoxynol phosphates, taurates, fatty taurides, fatty acid amide polyoxyethylene sulfates, isethionates, or mixtures thereof.

Particular examples of some suitable anionic surfactarits include, but are not limited to, C₈ -C₁₈ alkyl sulfates, C₈ -C₁₈ fatty acid salts, C₈ -C₁₈ alkyl ether sulfates having one or two moles of ethoxylation, C₈-C₁₈ alkamine oxides, C₈-C₁₈ alkoyl sarcosinates, C₈ -C₁₈ sulfoacetates, C₈-C₁₈ sulfosuccinates, C₈ -C₁₈ alkyl diphenyl oxide disulfonates, C₈ -C₁₈ alkyl carbonates, C₈-C₁₈ alpha-olefin sulfonates, methyl ester sulfonates, and blends thereof. The C₈-C₁₈ alkyl group may be straight chain (e.g., lauryl) or branched (e.g., 2-ethylhexyl). The cation of the anionic surfactant may be an alkali metal (e.g., sodium or potassium), ammonium, C₁-C₄ alkylammonium (e.g., mono-, di-, tri), or C₁-C₃ alkanolammonium (e.g., mono-, di-, tri).

Specific examples of such anionic surfactants include, but are not limited to, lauryl sulfates, octyl sulfates, 2-ethylhexyl sulfates, lauramine oxide, decyl sulfates, tridecyl sulfates, cocoates, lauroyl sarcosinates, lauryl sulfosuccinates, linear C₁₀ diphenyl oxide disulfonates, lauryl sulfosuccinates, lauryl ether sulfates (1 and 2 moles ethylene oxide), myristyl sulfates, oleates, stearates, tallates, ricinoleates, cetyl sulfates, and so forth.

The article of the present invention may be formed using a variety of processes, for example, dipping, spraying, tumbling, drying, and curing. An exemplary dipping process for forming a glove is described herein, though other processes may be employed to form various articles having different shapes and characteristics. For example, a condom may be formed in substantially the same manner, although some process conditions may differ from those used to form a glove. Furthermore, it should be understood that a batch, semi-batch, or a continuous process may be used with the present invention.

A glove is formed on a hand-shaped mold, commonly referred to as a “former.” The former may be made from any suitable material, such as glass, metal, porcelain, or the like. The surface of the former can be smooth or textured, and defines at least a portion of the surface of the glove to be manufactured. Typically, the glove is formed by dipping the former into a series of material compositions as needed to attain the desired glove characteristics. The glove may be allowed to solidify between applications of different layers. Any combination of layers may be used, and although specific layers are described herein, it should be understood that other layers and combinations of layers may be used as desired.

Where a coagulant based process is used, as in the case of forming a natural rubber glove, the former is first conveyed through a preheated oven to evaporate any water present from cleaning the former. The former is then dipped into a bath typically containing a coagulant, a powder source, a surfactant, and water. The residual heat evaporates the water in the coagulant mixture leaving, for example, calcium nitrate, calcium carbonate powder, and surfactant on the surface of the former. The coagulant may contain calcium ions (e.g., calcium nitrate) that enable a polymer latex, for example, a natural rubber latex or a nitrile rubber latex, to deposit onto the former. The powder may be calcium carbonate powder, which aids release of the completed glove from the former. The surfactant provides enhanced wetting to avoid forming a meniscus and trapping air between the form and deposited latex, particularly in the cuff area. However, any suitable coagulant composition may be used, including those described in U.S. Pat. No. 4,310,928 to Joung, incorporated herein in its entirety by reference.

The coated former is then dipped into a latex containing an elastomeric material that forms the substrate body. In some embodiments, the elastomeric material includes natural rubber, which may be supplied as a compounded natural rubber latex. Thus, the bath may contain, for example, compounded natural rubber latex, stabilizers, antioxidants, curing activators, organic accelerators, vulcanizers, and the like. The stabilizers may include phosphate-type surfactants. The antioxidants may be phenolic, for example, 2,2′-methylene-bis (4-methyl-6-t-butylphenol). The curing activator may be zinc oxide. The organic accelerator may be dithiocarbamate. The vulcanizer may be sulfur or a sulfur-containing compound. To avoid crumb formation, the stabilizer, antioxidant, activator, accelerator, and vulcanizer may first be dispersed into water by using a ball mill and then combined with the natural rubber latex.

During the dipping process, the coagulant on the former causes some of the elastomeric material to become locally unstable and coagulate onto the surface of the former. The elastomeric material coalesces, capturing the particles present in the coagulant composition at the surface of the coagulating elastomeric material. The former is withdrawn from the bath of elastomeric material and the coagulated layer is permitted to fully coalesce, thereby forming the substrate body. The former is dipped into one or more latex baths a sufficient number of times to attain the desired glove thickness. In some embodiments, the substrate body may have a thickness of from about 0.004 inches to about 0.012 inches.

The former is then dipped into a leaching tank in which hot water is circulated to remove the water-soluble components, such as residual calcium nitrates and proteins contained in the natural rubber latex. This leaching process may generally continue for about twelve minutes at a water temperature of about 120° F. The glove is then dried on the former to solidify and stabilize the substrate body. It should be understood that various conditions, process, and materials may be used to form the substrate body.

Other layers may be formed by including additional dipping processes. Such layers may be used to impart additional attributes to the glove. When these processes are complete, the former then undergoes an additional coating process to form the interior, or donning layer of the glove. It should be understood that any process may be used to form the donning layer, such as dipping, spraying, immersion, printing, tumbling or any other suitable technique.

Thus, for example, where a dipping process is used, the former is dipped into a composition that contains the donning layer polymer. In accordance with the present invention, the donning layer composition may include a modified vinyl acetate polymer. More particularly, the composition may include a silicone-modified vinyl acetate, such as that available from Reichhold Chemicals, Inc. under the trade name Synthemul® 97907-00, provided as a 46 mass % total solids content (TSC) emulsion. In some instances, the donning layer composition may include from about 0.5 mass % TSC to about 6 mass % TSC. In other embodiments, the donning layer composition may include from about 1 mass % TSC to about 5 mass % TSC. In other embodiments, the donning layer composition may include about 4 mass % TSC. In yet other embodiments, the donning layer composition may include about 2 mass % TSC.

The donning layer may be present in the finished elastomeric article any suitable amount, and in some embodiments, the donning layer may be present in an amount of from about 0.1% mass % to about 2.5 mass % of the elastomeric article. In other embodiments, the donning layer may be present in an amount of from about 0.25 mass % to about 1.5 mass % of the elastomeric article. In yet other embodiments, the donning layer may be present in an amount of about 0.5 mass % of the elastomeric article.

When the former is withdrawn from the composition, the substrate body coated with the donning layer composition is then sent to a curing station where the elastomeric material is vulcanized, typically in an oven. The curing station initially evaporates any remaining water in the coating on the former and then proceeds to a higher temperature vulcanization. The drying may occur at a temperature of from about 85° C. to about 95° C., with a vulcanization step occurring at a temperature of from about 110° C. to about 120° C. For example, the glove 20 may be vulcanized in a single oven at a temperature of 115° C. for about 20 minutes. Alternatively, the oven may be divided into four different zones with a former being conveyed through zones of increasing temperature. For instance, the oven may have four zones with the first two zones being dedicated to drying and the second two zones being primarily for vulcanizing. Each of the zones may have a slightly higher temperature, for example, the first zone at about 80° C., the second zone at about 95° C., a third zone at about 105° C., and a final zone at about 115° C. The residence time of the former within each zone may be about ten minutes. The accelerator and vulcanizer contained in the latex coating of the former are used to crosslink the natural rubber. The vulcanizer forms sulfur bridges between different rubber segments and the accelerator is used to promote rapid sulfur bridge formation.

It has been found that use of a modified vinyl acetate polymer, for instance a silicone-modified vinyl acetate polymer, affords a high degree of process flexibility m forming the elastomeric article of the present invention. In particular, it has been found that the donning layer may be formed prior to curing the article, as is described herein, or after the substrate body has been cured, as is described in the Examples.

Furthermore, where a natural rubber glove is being formed, it has been found that, contrary to process requirements of other donning layer polymers, use of a silicone-modified vinyl acetate polymer permits the final leaching step to be performed prior to or after formation of the donning layer. Thus, although a particular exemplary process is described above, it should be understood that use of a silicone-modified vinyl acetate polymer has enabled significant flexibility to be introduced into the process, and that such alternate processes are contemplated by the present invention. While not wishing to be bound to any particular theory, it is believed that the hydrophilic nature of the silicone-modified vinyl acetate polymer may cause the polymer to swell during the leaching process. As the silicone-modified vinyl acetate polymer particles expand, the spaces between the particles increase, thereby enabling the leaching water to flow to the substrate body and carry away excess proteins and chemicals. Alternatively, it is believed that the residual chemicals and proteins may migrate to the second surface of the substrate body and through the donning layer, where the chemicals and proteins are removed during the leaching process.

When all of the desired polymer layers have been formed and the glove is solidified, the former may be transferred to a stripping station where the glove is removed from the former. The stripping station may involve automatic or manual removal of the glove from the former. For example, in one embodiment, the glove is manually removed and turned inside out as it is stripped from the former. Where such a stripping process is used, it is typical to dip the former into a slurry containing calcium carbonate in water prior to proceeding to the stripping station. The former is then exposed to air to evaporate the water, leaving calcium carbonate particles on the surface of the donning layer. This enables the glove to roll over itself as it is stripped from the former without sticking to itself. Where such a slurry is used, the excess calcium carbonate is then removed during subsequent processing. Contrary to such typical instances, it has been discovered that no such slurry dip is needed to enable the glove of the present invention to be removed from the former. The silicone-modified-vinyl acetate polymer donning layer of the present invention is sufficiently non-tacky to be easily stripped from the former. This creates a significant advantage over gloves that must be subjected to cumbersome rinsing and drying steps to remove the calcium carbonate to create a “powder-free” glove.

Nonetheless, the solidified glove may then undergo to various post-formation processes. In some instances, the glove may be inverted as needed to expose the donning layer for halogenation. The halogenation (e.g., chlorination) may be performed in any suitable manner known to those skilled in the art. Chlorination generally entails contacting the surface to be chlorinated to a source of chlorine. Such methods include: (1) direct injection of chlorine gas into a water mixture, (2) mixing high density bleaching powder and aluminum chloride in water, (3) brine electrolysis to produce chlorinated water, and (4) acidified bleach. Examples of such methods are described in U.S. Pat. No. 3,411,982 to Kavalir; U.S. Pat. No. 3,740,262 to Agostinelli; U.S. Pat. No. 3,992,221 to Homsy, et al.; U.S. Pat. No. 4,597,108 to Momose; and U.S. Pat. No. 4,851,266 to Momose, U.S. Pat. No. 5,792,531 to Littleton, et al., which are incorporated herein in their entirety by reference. In one embodiment, for example, chlorine gas is injected into a water stream and then fed into a chlorinator (a closed vessel) containing the glove. The concentration of chlorine can be altered to control the degree of chlorination. The chlorine concentration is typically at least about 100 parts per million (ppm), in some embodiments from about 200 ppm to about 3500 ppm, and in some embodiments, from about 300 ppm to about 600 ppm, for example, about 400 ppm. The duration of the chlorination step may also be controlled to vary the degree of chlorination and may range, for example, from about 1 to about 10 minutes, for example, 4 minutes.

Still within the chlorinator, the chlorinated glove may then be rinsed with tap water at about room temperature. This rinse cycle may be repeated as necessary. Once all water is removed, the glove is tumbled to drain the excess water.

A lubricant composition may then be added into the chlorinator and tumbled for about five minutes. The lubricant forms a lubricant layer on at least a portion of the donning layer to further enhance donning of the glove. Any suitable lubricant may be used with the present invention as described herein. One such lubricant may include a quaternary ammonium compound such as VERISOFT® BTMS and a silicone emulsion such as SM 2169.

The lubricant solution is then drained from the chlorinator and may be reused if desired. It should be understood that the lubricant composition may be applied at a later stage in the forming process, and may be applied using any technique, such as dipping, spraying, immersion, printing, tumbling, or the like. The coated glove is then put into a drier and dried for about 10 to 60 minutes (e.g., 40 minutes) at from about 20° C to about. 80° C. (e.g.; 40° C.) to dry the inside surface of the glove. The glove is then inverted and the outside surface may be dried for about 20 to 100 minutes (e.g., 60 minutes) at from about 20° C. to about 80° C. (e.g., 40° C.).

These discoveries are evidenced by the following examples, which are not intended to be limiting in any manner.

### EXAMPLES 1-3

The ability to form a natural rubber article according to the present invention was demonstrated. In each instance; several glove formers were cleaned and dried. The formers were then dipped into a coagulant composition containing calcium nitrate, a surfactant, and other components. The coagulant on each former was then dried for about 35 seconds at a temperature of about 105° C., and then for about 35 seconds at a temperature of about 75° C.

The formers were then dipped into a 30 mass % high ammonia natural rubber latex composition to form the substrate body of each glove. The formers were then exposed to air to permit the substrate body to solidify on the surface of each former. The formers were exposed to air at a temperature of about 105° C. for about 65 seconds, then to air at a temperature of about 110° C. for about 35 seconds.

The substrate body on the former was then leached in circulating water at a temperature of about 45° C. for about 2 minutes to remove any residual proteins and coagulant chemicals.

### EXAMPLE 1

In this instance, the donning layer was formed over the substrate body prior to curing the natural rubber.

After forming the substrate body as described above, the formers were then dipped into a composition to form the donning layer. The composition included about 2 mass % Synthemul® 97907-00 silicone-modified vinyl acetate polymer in deionized water with inorganic particles, such as silica beads.

Each former was then sent to a bead rolling station where a bead was formed on the cuff of each glove. The polymer on the formers was then dried for about 67 seconds at a temperature of about 110° C.

The formers were then sent to a curing station having multiple temperature zones to vulcanize and solidify the natural rubber substrate body and the donning layer. The total amount of time required to cure the article was about 30 minutes. The gloves still on the formers were then leached in circulating water at a temperature of about 40° C. for about 2 minutes to remove residual proteins and chemicals. The gloves were then dried for about 67 seconds at a temperature of 110° C. and stripped from the formers.

The gloves were then donned by persons skilled in the art of making rubber gloves and who are familiar with donning and doffing such articles to evaluate the efficacy of the silicone-modified vinyl acetate donning layer. The gloves were found to be readily donned in comparison to gloves having a PVA coating alone, or without the use of powder conventional latex gloves.

### EXAMPLE 2

In this instance, the donning layer was formed over the substrate body after curing the natural rubber.

After forming the substrate body as described above, the formers were then sent to a curing station having multiple temperature zones to vulcanize and solidify the natural rubber substrate body and the donning layer. The total amount of time required to cure the article was about 30 minutes. The gloves still on the formers were then leached in circulating water at a temperature of about 40° C. for about 2 minutes to remove any residual proteins and chemicals. The gloves were then dried for about 67 seconds at a temperature of about 110° C.

The formers were then dipped into a composition to form the donning layer. The composition included about 4 mass % Synthemul® 97907-00 silicone-modified vinyl acetate polymer in deionized water with an amount of either silica, alumina, ceria, or titania particles.

Each former was then sent to a bead rolling station where a bead was formed on the cuff of each glove. The polymer on the formers was then dried for about 67 seconds at a temperature of about 110° C. The gloves were then stripped from the formers.

The gloves were then donned to evaluate the efficacy of silicone-modified vinyl acetate donning layer and found to be readily donned without the use of powder.

### EXAMPLE 3

The ability to form an article according to the present invention was demonstrated. In this instance, the donning layer was formed over the substrate body after curing the natural rubber. Also, the final leaching step was performed after formation of the donning layer to evaluate the flexibility of the process.

After forming the substrate body as described above, the formers were then sent to a curing station having multiple temperature zones to vulcanize and solidify the natural rubber substrate body and the donning layer. The total amount of time required to cure the article was about 30 minutes.

The formers were then dipped into a composition to form the donning layer. The composition included about 4 mass % Synthemul® 97907-00 silicone-modified vinyl acetate polymer in deionized water and an amount of organic and inorganic particles. The gloves were then dried for about 67 seconds at a temperature of about 110° C. The gloves still on the formers were then leached in circulating water at a temperature of about 40° C. for about 2 minutes to remove any residual proteins and chemicals.

Each former was then sent to a bead rolling station where a bead was formed on the cuff of each glove. The polymer on the formers was then dried for about 67 seconds at a temperature of about 110° C. The gloves were then stripped from the formers.

The gloves were then donned to evaluate the efficacy of silicone-modified vinyl acetate donning layer having particles incorporated therein, and found to be readily donned without the use of powder.

### EXAMPLES 4-6

The impact of leaching at various points in the natural rubber glove formation process was determined. In each of Examples 4-6, 135 glove formers were cleaned and dried. The formers were then dipped into a coagulant composition containing calcium nitrate, a surfactant, and other components. The coagulant on each former was then dried for about 35 seconds at a temperature of about 105° C., and then for about 35 seconds at a temperature of about 75° C.

The formers were then dipped into a 30 mass % high ammonia natural rubber latex composition to form the substrate body of each glove. The formers were then exposed to air to permit the elastomeric material to form a film on the surface of each former. The formers were exposed to air at a temperature of about 105° C. for about 65 seconds, then to air at a temperature of about 110° C. for about 35 seconds.

### EXAMPLE 4

In this instance, the glove formation process was simulated without any post-cure processing to determine the effect of leach time and temperature on the extractable protein level.

After formation of the substrate body as described above, the formers were dipped into a circulating water bath to leach any-residual chemicals and proteins from the substrate body. Fifteen formers were evaluated at each combination of the following conditions: leach times of 2 minutes, 5 minutes, and 8 minutes, and leach temperatures of 45° C., 60° C., and 75° C.

After leaching, the formers were dried at a temperature of about 110° C. for about 67 seconds.

The formers were then dipped into a composition to form the donning layer. The composition included about 2 mass % Synthemul® 97907-00 silicone-modified vinyl acetate polymer in deionized water and an amount of silica or zirconia particles. The gloves were then dried for about 67 seconds at a temperature of about 110° C., and stripped from the formers.

The formers were then sent to a curing station having multiple temperature zones to vulcanize and solidify the natural rubber substrate body and the donning layer. The total amount of time required to cure the article was about 30 minutes. The gloves were then evaluated by persons of skill in the art of forming natural rubber gloves for the ease-of removal or stripping form the former after curing. Like in Example 1 the gloves were found to be easily stripped from the formers in comparison to a conventional powder-free glove, or a glove having a PVA coating alone.

### EXAMPLE 5

In this instance, a post-cure leaching step was added to determine the impact on the protein reduction.

After formation of the substrate body as described above, the formers were dipped into a circulating water bath to leach any residual chemicals and proteins from the substrate body. The formers were leached for about 2 minutes in water bath was maintained at about 45° C. After leaching, the formers were dried at a temperature of about 110° C. for about 67 seconds.

The formers were then dipped into a composition to form the donning layer. The composition included about 2 mass % Synthemul® 97907-00 silicone-modified vinyl acetate polymer in deionized water and talcum, silica, or alumina particles. The formers were then sent to a curing station having multiple temperature zones to vulcanize and solidify the natural rubber substrate body and the donning layer. The total amount of time required to cure the article was about 30 minutes.

The formers were then subject to an additional leaching step. Fifteen formers were evaluated at each combination of the following conditions: leach times of 2 minutes, 5 minutes, and 8 minutes, and leach temperatures of 45° C., 60° C., and 75° C. The gloves were then dried at a temperature of about 110° C. for about 67 seconds and easily stripped from the formers.

### EXAMPLE 6

In this instance, the additional leaching step was performed prior to formation of the donning layer over the substrate body.

After formation of the substrate body as described above, the formers were dipped into a circulating water bath to leach any residual chemicals and proteins from the substrate body. The formers were leached for about 2 minutes in a water bath maintained at about 45° C. After leaching, the formers were dried at a temperature of about 110° C. for about 67 seconds.

The formers were then sent to a curing station having multiple temperature zones to vulcanize and solidify the natural rubber substrate body and the donning layer. The total amount of time required to cure the article was about 30 minutes.

The formers were then subject to an additional leaching step. Fifteen formers were evaluated at each combination of the following conditions: leach times of 2 minutes, 5 minutes, and 8 minutes, and leach temperatures of 45° C., 60° C., and 75° C. The gloves were then dried for about 67 seconds at a temperature of about 110° C.

The formers were then dipped into a composition to form the donning layer. The composition included about 4 mass % Synthemul® 97907-00 silicone-modified vinyl acetate polymer in deionized water and organic particles, such as oat, corn, or other starches. The gloves were then dried for about 67 seconds at a temperature of about 110° C., and easily stripped from the formers.

### EXAMPLE 7

The ability to form a nitrile butadiene rubber article according to the present invention was demonstrated. In each instance, several glove formers were cleaned and dried. The formers were then dipped into a coagulant composition containing calcium nitrate, a surfactant, and other components. The coagulant on each former was then dried for about 35 seconds at a temperature of about 105° C., and then for about 35 seconds at a temperature of about 75° C.

The formers were then dipped into a composition containing about 30 mass % nitrile rubber in water to form the substrate body of each glove. The formers were then exposed to air to permit the elastomeric material to form a film on the surface of each former. The formers were exposed to air at a temperature of about 105° C. for about 65 seconds, then to air at a temperature of about 110° C. for about 35 seconds.

The substrate body on the former was then leached in circulating water at a temperature of about 45° C. for about 2 minutes to remove any residual coagulant chemicals.

After forming the substrate body as described above, the formers were then dipped into a composition to form the donning layer. The composition included about 1.3 mass % Synthemul® 97907-00 silicone-modified vinyl acetate polymer in deionized water and incorporated acrylate or polymethacrylate particles.

Each former was then sent to a bead rolling station where a bead was formed on the cuff of each glove. The polymer on the formers was then dried in an oven at about 70° C. for about 20 minutes.

The formers were then sent to a curing station maintained at about 140° C. to vulcanize and solidify the nitrile butadiene rubber substrate body and the donning layer. The total amount of time required to cure the article was about 10 minutes. The gloves were then easily stripped from the formers.

The gloves were then donned to evaluate the efficacy of the silicone-modified vinyl acetate donning layer and found to be readily donned without the use of powder.

A silicone-modified vinyl acetate polymer incorporating organic or inorganic particles as a donning layer and the flexibility of the formation process is efficacious. Each of the gloves formed in the examples above was readily stripped from the formers and donned without the use of powders. In addition, the donning layer may be formed prior to curing or after curing the article. Furthermore, where a natural rubber article is being formed, the final leaching step may be performed prior to or after formation of the donning layer.

The present invention has been described in general and in detail by way of examples. Persons of skill in the art understand that the invention is not limited necessarily to the embodiments specifically disclosed, but that modifications and variations may be made without departing from the scope of the invention as defined by the following claims or their equivalents, including other equivalent components presently known, or to be developed, which may be used within the scope of the present invention. Therefore, unless changes otherwise depart from the scope of the invention, the changes should be construed as being included herein.

We claim:

1. A high friction elastomeric body having a relatively low friction layer with gross rugosity on at least a portion of a first surface of said elastomeric body, and a plurality of surface-area-contact reducing particles that have substantially smooth morphology distributed over said low friction layer, whereby said particles further reduce friction between said first surface and another surface.

2. A thin-walled, elastomeric article having a stable polymeric layer adapted to create a surface with gross rugosities when said article is exposed to a stretching force, and adapted to chemically adhere particles having exposed surface oxygens substantially permanently to said polymer layer, and said polymer layer and particles conferring a reduction in relative surface friction when donning said article.

3. The article according to claim 2, wherein said polymer layer is a network of a silicone-modified vinyl acetate polymer.

4. An article comprising an elastomeric or polymeric body having at least a first surface, said first surface being adapted to contact either another elastomeric surface or mammalian tissue, and said inner surface having a silicone-modified vinyl acetate polymer film with a plurality of particles incorporated substantially permanently therein by means of a mechanical or chemical adherence, wherein said particles constitute part of a surface coating.

5. The article according to claim 4, wherein said article includes either a natural or synthetic elastomeric material.

6. The article according to claim 5, wherein said elastomeric material is selected from: a natural rubber, polyisoprene, synthetic isoprene, nitrile rubbers, chloroprene, polyvinylchloride, polychloroprene, polyurethane, S-EB-S (styrene-ethylene-butylene-styrene) elastomeric block co-polymers, styrene-isoprene-styrene block copolymer, tyrene-butadiene-styrene block copolymer, styrene-isoprene block co-polymer, styrene-butadiene block copolymer, silicone rubber, or a combination thereof.

7. The article according to claim 4, wherein said silicone-modified vinyl acetate polymer is a polyvinyl acetate-silicone (PVA-SiO).

8. The article according to claim 4, wherein said particles are in a polymer matrix, which prevents said particles from spalling or popping out of said coating when said article is stretched.

9. The article according to claim 4, wherein said particles are associated with at least a portion of said silicone-modified vinyl acetate polymer by means of either a primary or secondary chemical attachment.

10. The article according to claim 9, wherein said particles are attached directly to a polymer backbone of said silicone-modified vinyl acetate polymer.

11. The article according to claim 9, wherein said particles have a reactive moiety that can react with said polymer backbone of said silicone-modified vinyl acetate polymer to form either an acetate linkage, ester linkage, an ether linkage, or an urethane linkage.

12. The article according to claim 9, wherein said particles are modified with an organic component having either a hydroxyl, or a carboxyl or carbonyl acid or aldehyde functional group.

13. The article according to claim 10, said particles are copolymerized with a monomer that results in a direct bond of said particle to said acetate linkages or hydroxyl moiety.

14. The article according to claim 4, wherein said particles composed of an organic material.

15. The article according to claim 14, wherein said organic material may include:, oat, corn, or other starches, silicone, silane, siloxane, acrylate or polymethacrylate, or high-molecular weight (≧5,000) polyolefin polymers.

16. The article according to claim 4, wherein said particles composed of an inorganic material.

17. The article according to claim 16, wherein said inorganic material may include: talcum (Mg₃Si₄O₁₀(OH)₂), silica (SiO₂), alumina (Al₂O₃), titania (TiO₂), zirconia (ZrO₂), CaO₂, ZnO₂, Cr₂O₃, CeO₂, Ge₂O₃, or other oxides of transition metals or rare earth metals, glass or ceramic beads, or organically-modified inorganic beads.

18. The article according to claim 4, wherein said particles are made of silica.

19. The article according to claim 4, wherein each individual particle has a smooth morphology, absent sharp edges that may catch or damage tissue or elastomeric material.

20. The article according to claim 19, wherein said particles have generally either a perfect spheroid, or irregular or elongated oblate forms.

21. The article according to claim 4, wherein said particles range in size from about 0.01 μm to about 150 μm.

22. The article according to claim 21, wherein said particles range in size from about 1-2 μm, up to about 75 μm.

23. The article according to claim 21, wherein said particles range in size from about 10 μm to about 50 μm.

24. The article according to claim 4, wherein said coating contains a distribution of particles with either the same or different sizes.

25. The article according to claim 4, wherein said particles constitute about 2 wt. % to about 35 wt. % of said coating.

26. The article according to claim 24, wherein said particles constitute about 5 wt. % to about 25 wt. % of said coating.

27. The article according to claim 4, wherein said article is one of the following: a surgical glove, examination or work glove, condom, catheter, balloon, or tubing.

28. A glove having a elastomeric or polymeric body having an inner and an outer surface, said inner surface having a donning layer with a silicone-modified vinyl acetate polymer film and a number of organic or inorganic particles incorporated therein by means of a mechanical or chemical adherence to said polymer film, wherein said particles constitute part of a low friction surface coating.

29. The glove according to claim 28, wherein said silicone-modified vinyl acetate polymer is a polyvinyl acetate-silicone (PVA-SiO).

30. The glove according to claim 28, wherein said particles are in a polymer matrix, which prevents said particles from spalling or popping out of said coating when said article is stretched.

31. The glove according to claim 28, wherein said particles are associated with at least a portion of said silicone-modified vinyl acetate polymer by means of either a primary or secondary chemical attachment.

32. The glove according to claim 31, wherein said particles are attached directly to a polymer backbone of said silicone-modified vinyl acetate polymer.

33. The glove according to claim 28, wherein said silicone-modified vinyl acetate polymer contains from about 10 atomic % to about 35 atomic % silicon.

34. A method for preparing an elastomeric article, the method comprises: preparing a substrate body made from an elastomeric material, the substrate body having a first surface; and forming a donning layer over at least a portion of said first surface, the donning layer comprising a silicone-modified vinyl acetate polymer and a number of organic or inorganic particles incorporated therein by means of chemical attachment to a polymer backbone of said polymer.

35. The method according to claim 34, wherein said method further comprises either curing the elastomeric materials before or after forming said donning layer.

36. The method according to claim 34, wherein said method further comprises forming a lubricant layer over at least a portion of said donning layer, the lubricant layer comprising a silicone emulsion.

37. The method according to claim 34, wherein said particles have a reactive moiety that can react with said polymer backbone to form either an acetate linkage, ester linkage, an ether linkage, or an urethane linkage.

38. The method according to claim 34, wherein said particles are modified with an organic component having either a hydroxyl, or a carboxyl or carbonyl acid or aldehyde functional group.

39. The method according to claim 34, wherein said particles are composed of an organic material selected from at least one of the following: oat, corn, or other starches, silicone, silane, siloxane, acrylate or polymethacrylate, or high-molecular weight (e.g., ≧5,000) polyolefin polymers.

40. The method according to claim 34, wherein said particles are composed of an inorganic material selected from at least one of the following: talcum (Mg₃Si₄O₁₀(OH)₂), silica (SiO₂), alumina (Al₂O₃), titania (TiO₂), zirconia (ZrO₂), CaO₂, ZnO₂, Cr₂O₃, CeO₂, Ge₂O₃, or other oxides of transition metals or rare earth metals, glass or ceramic beads, or organically-modified inorganic beads.

41. The method according to claim 34, wherein said particles are made of silica.

42. The method according to claim 34, wherein each individual particle has a smooth morphology.

43. The method according to claim 34, wherein said particles range in size from about 0.05 μm to about 150 μm.
